(19) United States
(12) Patent Application Publication
(10) Pub. No.: US 2010/0004964 A1
(43) Pub. Date: Jan. 7, 2010

(54) Intention Driven Business Process Modeling

(76) Inventor: Robert Heidasch, Eichendorffstr (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/168,848

(22) Filed: Jul. 7, 2008

(51) Int. Cl. G06Q 99/00

(52) U.S. Cl. 705/7

(57) ABSTRACT

An intention-driven business process modeling system and method are presented. User input is received defining one or more actions related to a real business process. The one or more actions are combined in a logical group to create an intention model, the intention model including business-specific actions to be performed according to the logical group. An application programming interface is defined for each business-specific action. An event model is then defined to generate an event handler to interface with the application programming interface of each business-specific action to execute each action of the intention model.

### FIELD

This disclosure relates generally to service oriented architecture of enterprise processing systems, and more particularly to a business process modeling using a specialized business function called an “intention”.

### BACKGROUND

Business process modeling is a main element of an enterprise service oriented architecture (SOA), such as SAP's Enterprise SOA solution, which allows the building or composing of models of real business processes. The business processes are supported by business objects that contain business-related data, and the business processes often perform some steps and/or actions that result in the changing of business-related data and states of the business objects.

These steps and/or actions, which make up at least part of loosely-coupled services of the business processes, are presently not combined into one logical group. In existing SOA solutions, business process execution is focused on business objects and their data and states. Data and state changes are done using business object operations, e.g. implemented by Web services. The particular steps and/or actions are defined separately, and later combined to compose or build a particular business process. The steps and/or actions may throw events (including problems) that are handled by a local or global event manager.

Consequently, the business process models are not related to the actions, nor oriented to the business objects.

### SUMMARY

The subject matter disclosed herein provides methods and apparatus, including computer program products, for intention-driven business process modeling.

In one aspect, a system includes a business process modeler. The business process modeler configures and executes the data flow-oriented business processes. Accordingly, actions are logically grouped into business functions called “intentions”. First, an intention is defined (what should be accomplished), and then actions to be performed to achieve the intention are defined. The actions, and interactions between actions (e.g. events), are handled internally in an intention implementation (one software component) and using a local event handling mechanism.

Each intention can be defined as an abstract intention, such as a template, which defines is required from a technical and/or supporting perspective (e.g. event handler) as well as any particular actions to accomplish the intention. The intention, its actions and events can be refined in a development process. This solution significantly accelerates and simplifies the development process, especially for customer systems.

In one aspect there is provided a method. The method includes a computer-readable medium containing instructions to configure a processor to perform a method. The method includes receiving user input to define one or more actions related to a real business process, and combining the one or more actions in a logical group to create an intention model, the intention model including business-specific actions to be performed according to the logical group. The method further includes defining an application programming interface for each business-specific action. The method further includes defining an event model to generate an event handler to interface with the application programming interface of each business-specific action to execute each action of the intention model.

In another aspect, a computer-implemented method includes the steps of receiving user input to define one or more actions related to a real business process, and combining the one or more actions in a logical group. The method further includes creating an intention model, the intention model including business-specific actions to be performed according to the logical group. The method further includes defining an application programming interface for each business-specific action, and defining an event model to generate an event handler to interface with the application programming interface of each business-specific action to execute each action of the intention model.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWING

These and other aspects will now be described in detail with reference to the following drawings.

FIG. 1 illustrates a system for performing intention-driven business process modeling.

FIG. 2 illustrates an embodiment of a business intention.

FIG. 3 illustrates an embodiment of a business process model.

FIG. 4 an intention-driven business process modeling method.

Like reference symbols in the various drawings indicate like elements.

### DETAILED DESCRIPTION

The subject matter described herein relates to intention-driven business process modeling systems and methods. An intention is a desire that something be accomplished. A business intention is a desire that a business process-oriented solution be accomplished. As used herein, the simple term “intention” refers to a business intention. By representing an intention as a special kind of business functional object, intentions can be used to build logically grouped business-related activities to be accomplished by a SOA platform. An intention can define business-specific activities, and may consist of one or more steps and/or actions (hereinafter referred to only as “actions”). The intention is defined by a modeler program using modeling notation, and the definition is called an intention model.

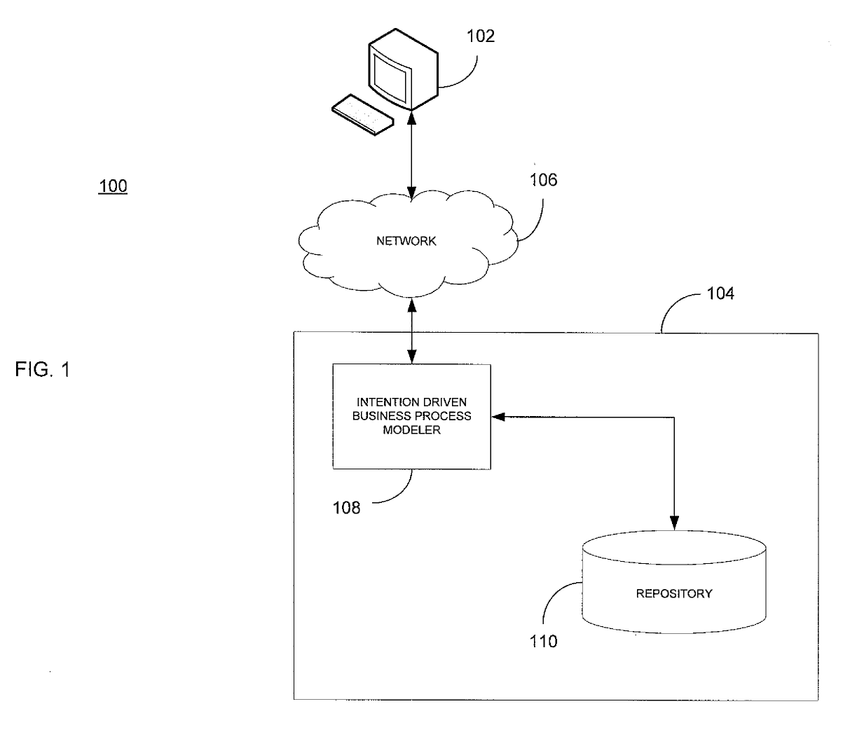

FIG. 1 depicts an exemplary system 100 for intention-driven business process modeling. The system 100 includes a client system 102 coupled to a server system 104 through a network 106 (e.g., the Internet or an intranet). The client system 102 and server system 104 may be implemented as one or more processors, such as a computer, a server, a blade, and the like.

The server system 104 includes a repository 110. The repository 110 can be organized as a database and implemented as a data warehouse, and include data structured as a snowflake schema, datacube, a star schema, or any other data structure. The repository 110 includes structured data, such as data types, business objects, services and the like. The term “data type” refers to a data definition and its structure including at least one of data and related metadata, while the phrase “business object” and “service” refers to an object and its method used in connection with a business process or a task.

The server system 104 further includes an intention-driven modeler 108 for modeling steps and/or actions that define real business processes. The modeler 108 can include models that can be used by the client system 102 to model business processes based on intention models. The models can be downloaded to the client system 102 for local use, or executed on the server system 104 as a Web service or other client-oriented tool.

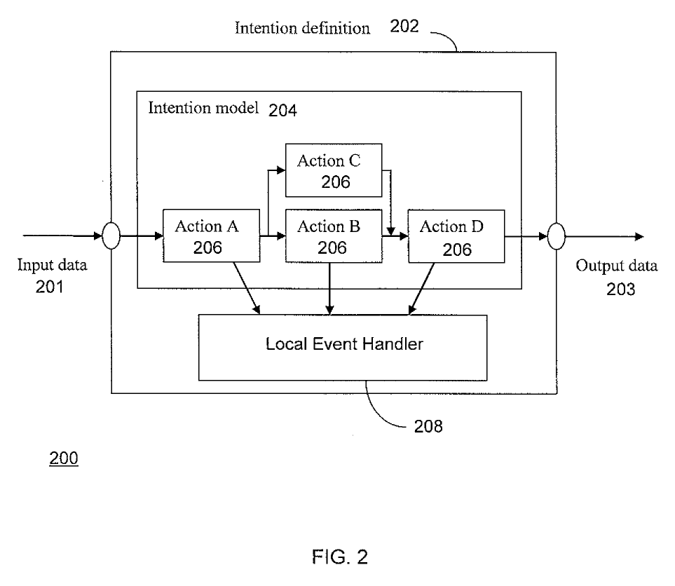

As shown in FIG. 2, a business intention 200 includes an intention definition 202. The intention definition 202 includes an intention model 204 that describes the functional aspects of an intention, the format of the requited input data 201 and the format of the output data 203 (which data structures are used to process a particular intention. The functional aspects of the intention are defined by the intention model 204 as one or more logically interconnected actions 206 (Actions A-D in the FIG. 2). The actions 206 specify the one or more steps and/or actions that must be performed in order to accomplish the business intention 200.

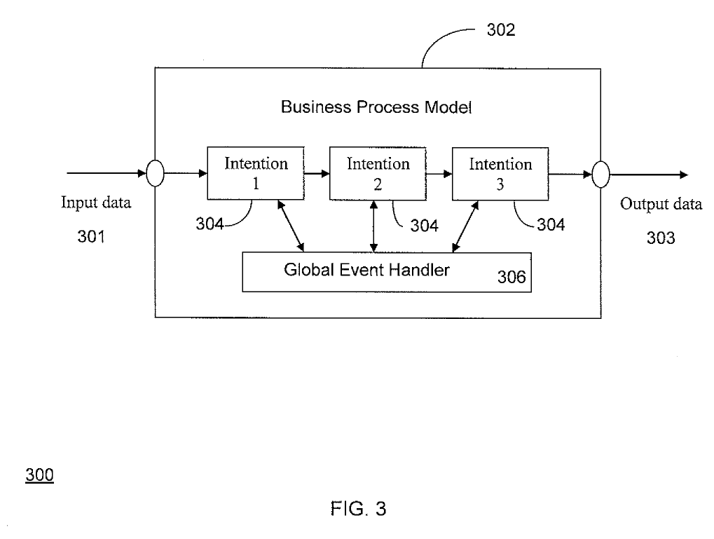

Each action 206 is implemented as a service (e.g. Web service), and is defined using a separate interface (API) and action implementation (one or many classes, functions, etc.). Each action 206 operates on input data 201 which is defined by an input interface (API) and the action result is published as output data 203. The output data 203 is defined by an output interface (API). The output data 203 can be used to process further actions which are defined in the same business intention 200 or in a next intention, as shown in FIG. 3.

The intention definition 202 further includes an internal events handler 208 that is used to perform particular business-related events according to the actions 206 for one business process.

Each intention is identified by an intention identifier (intention ID) a unique intention name or identification. Each action/step is identified by intention ID and action ID. The intention model 204 and an event model in the internal event handler 208 can be defined abstractly, i.e. independent of the input data 201 and/or output data 203. Thus, the intention definition 202 can be used as a template to define data-specific and ready-to-run intentions, which significantly accelerates and simplifies the development and business integration processes.

According to one exemplary implementation, a business intention can be an approval intention. In a first step, the input data is checked (e.g. consistency check), and then assigned to the responsible person (or persons or groups) to be approved or rejected. All this actions can raise exceptions/events that ate handled by the intention specific event handler (an intention internal/local event handler). The approval intention can be extended/used to define next, business-specific intensions, e.g. invoice approval, material usage approval, vacancy approval, etc.

The business intention 200 is preferably implemented in one software component, i.e. without cross software component interactions inside of any particular business intention 200, because of event handling and performance reasons. The software component may implement many actions that are used to define different intentions, this means that many actions and intentions can be defined in the particular software component. Thus, definitions of certain actions 206 can be reused in different intentions. This solution helps to enlarge reusability of the particular intention elements which can be used by a customer to define customer-specific intentions, for example. If the software component consists of one intention, the intention can be defined as deployment unit. Each intention 200 has its own version.

As described above, beside the intention model 204, the intention definition 202 also includes the internal event handler 208 which is integrated with the particular actions 206 of a business process. Each action 206 may trigger an event which causes some other action 206. The event—action relation is defined/modeled in the internal event handler 208. The events may trigger internal intention calls (e.g. a call to the local actions).

Events may trigger internal calls among two or more intentions used by the same business process and used by a business-specific internal event handler 208, and may trigger cross-calls to other business processes, in which the business specific internal event handler 208 may communicate with other business specific event handlers, the combination of which defines a global event handler 306, as particularly shown in FIG. 3.

Each intention's actions 206 and internal event handler 208 (intention-internal and process specific) are integrated with a business process monitoring system that allows the easy detection and presentation (e.g. graphical) of intention state, flow and problems/errors.

The business intentions 200 can be used to build a business process model 302 for a business process 300, as shown in FIG. 3. In this case, a chain of business intentions 304 builds a logical structure of a business process model 302 of the particular business process 300. The business process 300 executes the chain of business intentions 304 on input data 301 to produce output data 303 according to the business process model 302.

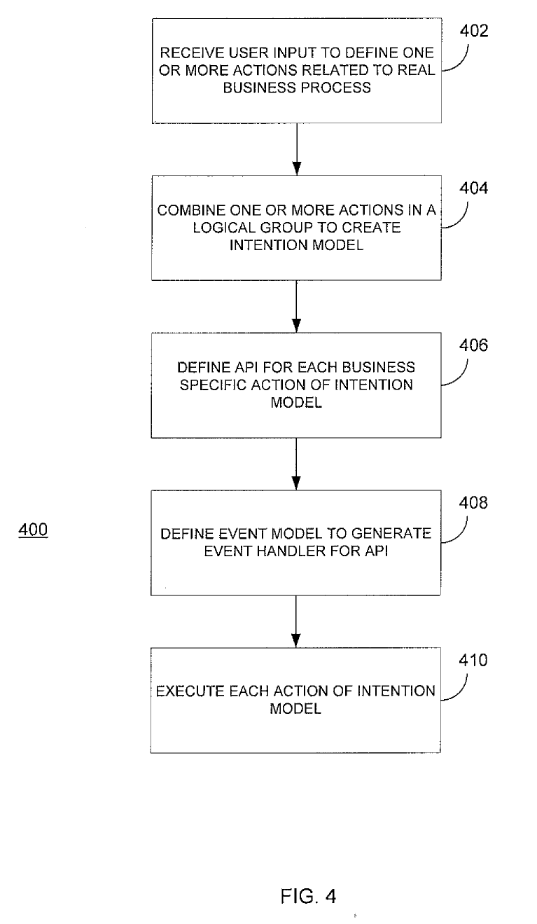

FIG. 4 an intention-driven business process modeling method 400. At 402, user input is received. The user input defines one or more actions related to a real business process or processes. The user input can be instructions, or can be a selection of a graphical representation of an object or functionality of a business process. At 404, the one or more actions are combined in a logical group by a computer to create an intention model.

At 406, an application programming interface (API) is defined for each business-specific action of the intention model created at 404. Then, at 408, an event model is defined. The event model is configured to generate an event handler for each API. At 410, each action of the intention model is executed by an associated event handler. The collection of event handlers in turn define a global event handler for the intention model.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially constructed for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Although the description above refers to a client and a server, other frameworks and architectures may be used as well. For example, the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components.

As used herein, the term “user” may refer to any entity including a person or a computer.

The foregoing description is intended to illustrate but not to limit the scope of the invention, which is defined by the scope of the appended claims. Other embodiments are within the scope of the following claims.

What is claimed:

1. A computer-readable medium containing instructions to configure a processor to perform a method, the method comprising:
receiving user input to define one or more actions related to a real business process;
combining the one or more actions in a logical group to create an intention model, the intention model including business-specific actions to be performed according to the logical group;
defining an application programming interface for each business-specific action; and
defining an event model to generate an event handler to interface with the application programming interface of each business-specific action to execute each action of the intention model.

2. The method in accordance with claim 1, wherein each business-specific action is implemented as a service

3. The method in accordance with claim 2, wherein the service is a Web service.

4. The method in accordance with claim 1, wherein the intention model defines an intention, and wherein the intention is identified by an intention ID.

5. The method in accordance with claim 4, wherein each business-specific action is identified by an action ID and an intention ID of an intention in which the business-specific action is associated.

6. A computer-implemented method comprising:
receiving user input to define one or more actions related to a real business process;
combining the one or more actions in a logical group;
creating an intention model, the intention model including business-specific actions to be performed according to the logical group;
defining an application programming interface for each business-specific action; and
defining an event model to generate an event handler to interface with the application programming interface of each business-specific action to execute each action of the intention model.

7. The method in accordance with claim 6, wherein each business-specific action is implemented as a service

8. The method in accordance with claim 7, wherein the service is a Web service.

9. The method in accordance with claim 6, wherein the intention model defines an intention, and wherein the intention is identified by an intention ID.

10. The method in accordance with claim 9, wherein each business-specific action is identified by an action ID and an intention ID of an intention in which the business-specific action is associated.

11. An enterprise processing system comprising:
a business process modeler running in a server system and configured to receiving user input over a network, the user input to define one or more actions related to a real business process, the business process modeler being configured to combine the one or more actions in a logical group to create an intention model, the intention model including business-specific actions to be performed according to the logical group;
an application programming interface defined for each business-specific action; and
an event handler generated by an event model to interface with the application programming interface of each business-specific action to execute each action of the intention model.

12. The system in accordance with claim 11, wherein each business-specific action is implemented as a service

13. The system in accordance with claim 12, wherein the service is a Web service.

14. The system in accordance with claim 11, wherein the intention model defines an intention, and wherein the intention is identified by an intention ID.

15. The system in accordance with claim 14, wherein each business specific action is identified by an action ID and an intention ID of an intention in which the business-specific action is associated.
